(19) United States
(12) Patent Application Publication
(10) Pub. No.: US 2025/0306957 A1
(43) Pub. Date: Oct. 2, 2025

(54) PAGE DISPLAY METHOD AND APPARATUS, STORAGE MEDIUM, AND ELECTRONIC DEVICE

(71) Applicant: Douyin Vision Co., Ltd., Beijing (CN)

(72) Inventors: Qiang YU, Beijing (CN); Zaojun HUANG, Beijing (CN)

(21) Appl. No.: 18/865,305

(22) PCT Filed: Aug. 21, 2023
(86) PCT No.: PCT/CN2023/114095

§ 371 Date: Nov. 12, 2024

(30) Foreign Application Priority Data
Sep. 16, 2022 (CN) 202211130221.1

(51) Int. Cl. G06F 9/445; G06F 9/451

(52) U.S. Cl. CPC G06F 9/44505; G06F 9/44526; G06F 9/451

(57) ABSTRACT

A page display method includes: determining, in response to a startup of a target client, whether the target client is started for a first time; in response to determining that the target client is started for the first time, starting a target application in the target client; obtaining linked application data and display configuration information by a preset plug-in, where the linked application data includes a plurality of linked applications corresponding to the target application; determining, based on the display configuration information, whether to display a linked application page after an application exits; and in response to determining that the linked application page is to be displayed, ending the target application in the target client and displaying, by the preset plug-in and in the target client, the linked application page according to the linked application data in response to receiving an exit trigger for the target application.

### CROSS-REFERENCE TO RELATED APPLICATION(S)

The present application claims priority to Chinese Patent Application No. 202211130221.1, filed with the China National Intellectual Property Administration on Sep. 16, 2022 and entitled “PAGE DISPLAY METHOD AND APPARATUS, STORAGE MEDIUM, AND ELECTRONIC DEVICE”, which is incorporated herein by reference in its entirety.

### FIELD

The present disclosure relates to the field of page display technologies, and in particular, to a page display method and apparatus, a storage medium, and an electronic device.

### BACKGROUND

An application store is an important channel for users to download applications. Currently, there are mainly four types of application stores on the market: an application store built in a mobile phone by a mobile phone manufacturer; an application store from a mobile phone system; an application store from a third party; and a mobile application store from an operator.

The above several application stores all belong to centralized stores, that is, a user must first separately download an application store, and then can download and install other applications in the application store. After installing other applications, if the user no longer needs the functions of the applications, the applications are no longer valuable. For users, this application distribution method requires additional download of an application store, and also requires timely cleaning of applications that are no longer valuable, which is complicated to operate.

### SUMMARY

This Summary is provided to introduce a selection of concepts in a simplified form that are further described below in the Detailed Description of Embodiments. This Summary is not intended to identify key features or essential features of the claimed subject matter, nor is it intended to be used to limit the scope of the claimed subject matter.

In a first aspect, the present disclosure provides a page display method, including:
determining, in response to a startup of a target client, whether the target client is started for a first time;
in response to determining that the target client is started for the first time, starting a target application in the target client, where the target application corresponds to the target client;
obtaining linked application data and display configuration information by a preset plug-in, where the linked application data includes a plurality of linked applications corresponding to the target application;
determining, based on the display configuration information, whether to display a linked application page after an application exits; and
in response to determining that the linked application page is to be displayed after the application exits, ending the target application in the target client and displaying, by the preset plug-in and in the target client, the linked application page including the plurality of linked applications according to the linked application data in response to receiving an exit trigger for the target application.

In a second aspect, the present disclosure provides a page display apparatus, including:
a client startup module configured to determine, in response to a startup of a target client, whether the target client is started for a first time;
an application startup module configured to, in response to determining that the target client is started for the first time, start a target application in the target client, where the target application corresponds to the target client;
a plug-in processing module configured to obtain linked application data and display configuration information by a preset plug-in, where the linked application data includes a plurality of linked applications corresponding to the target application;
a configuration determination module configured to determine, based on the display configuration information, whether to display a linked application page after an application exits; and
a page display module configured to, in response to determining that the linked application page is to be displayed after the application exits, end the target application in the target client and display, by the preset plug-in and in the target client, the linked application page including the plurality of linked applications according to the linked application data in response to receiving an exit trigger for the target application.

In a third aspect, the present disclosure provides a computer-readable storage medium having a computer program stored thereon, where the program implements, when is executed by a processing apparatus, the steps of the method described in the first aspect.

In a fourth aspect, the present disclosure provides an electronic device, including:
a storage apparatus having a computer program stored thereon; and
a processing apparatus configured to execute the computer program in the storage apparatus to implement the steps of the method described in the first aspect.

The page display method provided in the present disclosure enables any client to run an application and display a linked application linked thereto in a decentralized manner. After the target client is started for the first time, the corresponding target application is normally started in the foreground, and the corresponding linked application data and display configuration information are requested in the background by using the preset plug-in. Therefore, the experience of the user in actually using the application will not be affected, and it is also beneficial to display, in a page according to the obtained linked application data when the user exits the target application, a linked application page to implement application distribution.

Other features and advantages of the present disclosure will be described in detail in the following specific implementation manners.

### BRIEF DESCRIPTION OF THE DRAWINGS

The above and other features, advantages, and aspects of the embodiments of the present disclosure become more apparent with reference to the following specific implementations and in conjunction with the accompanying drawings. Throughout the drawings, the same or similar reference numerals denote the same or similar elements. It should be understood that the accompanying drawings are schematic and that parts and elements are not necessarily drawn to scale. In the drawings:

FIG. 1 is a flowchart of a page display method according to an exemplary embodiment of the present disclosure;

FIG. 2 is a flowchart of a page display method according to another exemplary embodiment of the present disclosure based on FIG. 1;

FIG. 3 is a schematic diagram of a linked application page according to an exemplary embodiment of the present disclosure;

FIG. 4 is a block diagram of a page display apparatus according to an exemplary embodiment of the present disclosure; and

FIG. 5 is a block diagram of an electronic device according to an exemplary embodiment of the present disclosure.

### DETAILED DESCRIPTION OF EMBODIMENTS

Embodiments of the present disclosure will be described in more detail below with reference to the accompanying drawings. Although some embodiments of the present disclosure are shown in the drawings, it should be understood that the present disclosure may be implemented in various forms and should not be construed as being limited to the embodiments set forth herein. On the contrary, these embodiments are provided for a more thorough and complete understanding of the present disclosure. It should be understood that the accompanying drawings and embodiments of the present disclosure are only for illustrative purposes, and are not intended to limit the scope of protection of the present disclosure.

It should be understood that the various steps described in the method implementations of the present disclosure may be performed in different orders, and/or performed in parallel. In addition, additional steps may be included and/or the execution of the illustrated steps may be omitted in the method implementations. The scope of the present disclosure is not limited in this regard.

The term “include/comprise” used herein and the variations thereof are an open-ended inclusion, namely, “include/comprise but not limited to”. The term “based on” is “at least partially based on”. The term “an embodiment” means “at least one embodiment”. The term “another embodiment” means “at least one another embodiment”. The term “some embodiments” means “at least some embodiments”. Related definitions of other terms will be given in the description below.

It should be noted that the concepts such as “first” and “second” mentioned in the present disclosure are only used to distinguish different apparatuses, modules, or units, and are not used to limit the sequence of functions performed by these apparatuses, modules, or units or interdependence.

It should be noted that the modifiers “one” and “a plurality of” mentioned in the present disclosure are illustrative and not restrictive, and those skilled in the art should understand that unless the context clearly indicates otherwise, it should be understood as “one or more”.

The names of messages or information exchanged between a plurality of apparatuses in the implementations of the present disclosure are used for illustrative purposes only, and are not used to limit the scope of these messages or information.

All actions of acquiring signals, information, or data in the present disclosure are performed on the premise of complying with the corresponding data protection regulations and policies of the country/region where the present disclosure is located, and with the authorization of the corresponding apparatus owner.

Based on the technical problems in the related art, an embodiment of the present disclosure provides a page display method, which enables any client to run an application and display a linked application linked thereto in a decentralized manner, and run the linked application. It should be noted that the application referred to in the present disclosure may be a game application or another non-game application. For ease of description, in the following embodiments, the present disclosure is mainly described by taking a game application as an example.

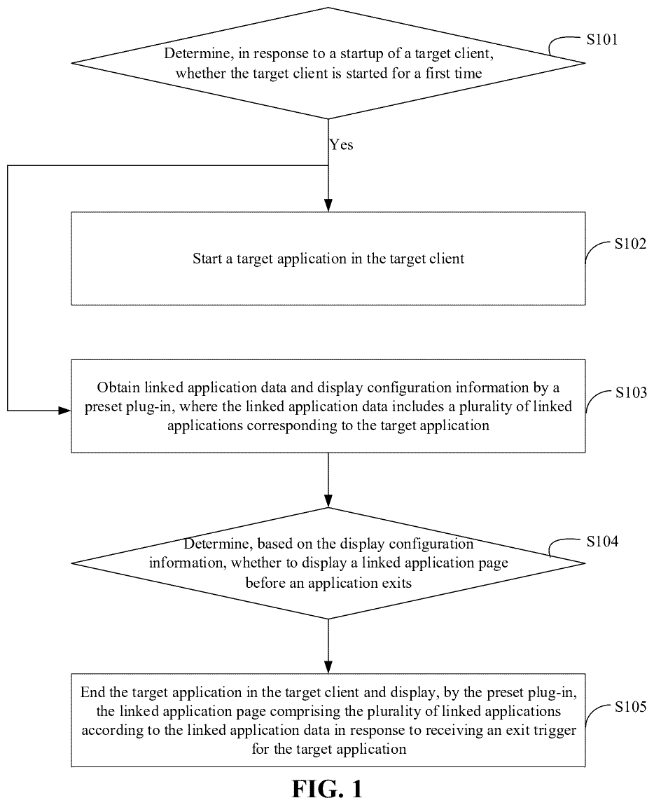

FIG. 1 shows a flowchart of a page display method according to an exemplary embodiment. Referring to FIG. 1, the method includes the following:

S101: in response to a startup of a target client, whether the target client is started for a first time is determined. If the target client is started for the first time, the process proceeds to step S102.

The target client is a client formed after the page display method of the present disclosure is integrated for any application.

S102: a target application is started in the target client, where the target application corresponds to the target client.

In response to the startup of the target client, whether the target client is started for the first time is determined. If the target client is started for the first time, the target application corresponding to the target client is started in the target client.

For example, the target application is an application corresponding to an icon of the target client.

By taking a game A as an example, a target client of “Game A” is downloaded and installed on a device, and after the installation is completed, a game icon and a game name of “Game A” are displayed on a desktop. It can be understood that the original requirement of the user for downloading the target client of “Game A” is to play “Game A”. Therefore, when the target client is started for the first time, the “Game A” is determined as the target application according to the icon of the target client, and the “Game A” is started and run in the target client.

S103: linked application data and display configuration information are obtained by a preset plug-in, where the linked application data includes a plurality of linked applications corresponding to the target application.

In an exemplary embodiment, after the target client is started for the first time, the following operations may be performed: obtaining configured plug-in requirement information from the target client, and requesting a corresponding plug-in from a server based on a plug-in requirement in the plug-in requirement information, where the plug-in requirement information is configured based on a function required by an application corresponding to the target client when the target client is packaged and generated. For example, if the application corresponding to the target client requires an advertisement function, a requirement for an advertisement plug-in is configured in the plug-in requirement information. If the application corresponding to the target client requires a push function, a requirement for a push plug-in is configured in the plug-in requirement information. If the application corresponding to the target client requires a linked application page display function, a requirement for the preset plug-in is configured in the plug-in requirement information. The advertisement plug-in, the push plug-in, and the preset plug-in are respectively requested from the server for downloading based on the plug-in requirement information configured in the target client, so that the advertisement plug-in, the push plug-in, and the preset plug-in are installed in the target client.

After the preset plug-in is installed, the linked application data and the display configuration information are obtained by the preset plug-in, where the linked application data includes the plurality of linked applications corresponding to the target application.

It can be understood that the steps of downloading and installing the plug-ins and the step of obtaining the linked application data and the display configuration information by the installed preset plug-in may be asynchronously performed with step S102.

S104: whether to display a linked application page after an application exits is determined based on the display configuration information. If the linked application page is to be displayed after the application exits is determined, the process proceeds to step S105.

The display configuration information includes a configuration of “whether to display a linked application page after an application exits”. After the linked application data and the display configuration information are obtained by using the preset plug-in, whether to display the linked application page after the application exits is determined based on the display configuration information.

Optionally, the display configuration information may further include a configuration of “whether to display a linked application page before an application starts”.

The step may be asynchronously performed with step S102. As an example, the linked application data and the display configuration information may be obtained by the preset plug-in during running of the target application, and whether to display the linked application page after the application exits is determined based on the display configuration information.

S105: in response to receiving an exit trigger for the target application, the target application is ended in the target client, and the linked application page including the plurality of linked applications is displayed by using the preset plug-in and in the target client according to the linked application data.

If it is determined that the linked application page is to be displayed after the application exits, the target application is ended in the target client and the linked application page including the plurality of linked applications is displayed in the target client by using the preset plug-in according to the linked application data in response to receiving the exit trigger for the target application. Therefore, when the target client is started for the first time, the target application that the user expects to run is normally started by default, and then the linked application page is displayed in the target client after the running of the target application ends. The linked application page includes the plurality of linked applications linked to the target application, so that the user can select a linked application in the linked application page.

In a specific embodiment, after the linked application page including the plurality of linked applications is displayed in the target client by using the preset plug-in according to the linked application data, the method further includes: starting, in the target client in response to a user selecting an application from the plurality of linked applications in the linked application page, the selected application.

Therefore, after the linked application page is displayed in the target client, the user can browse the linked application page and select an application that the user is interested in from the plurality of linked applications in the linked application page, to start the interested application selected by the user in the target client.

It can be seen that the target client can run the target application and display the linked application linked thereto by the linked application page, and run the linked application selected by the user, so that the target client has an application distribution function.

In addition, if it is determined that the linked application page is not to be displayed after the application exits, the target client may be directly exited.

It can be seen from the foregoing process that the target client in the present disclosure integrates only some basic functions, and all functions such as an advertisement function, a push function, and a page display function are encapsulated into corresponding plug-ins, and a client installation package is separated from the plug-ins, so that the actual installation package size of the target client is reduced. Therefore, the target client is quickly downloaded, installed, and started. After the target client is started for the first time, the target application is normally started in the foreground, and the various plug-ins are requested in the background according to the plug-in requirement information, and then the corresponding linked application data and display configuration information are requested from the server by the preset plug-in. Therefore, the experience of the user in actually using the application will not be affected, and it is also beneficial to display, in a page according to the obtained linked application data when the user exits the target application, a linked application page to implement application distribution.

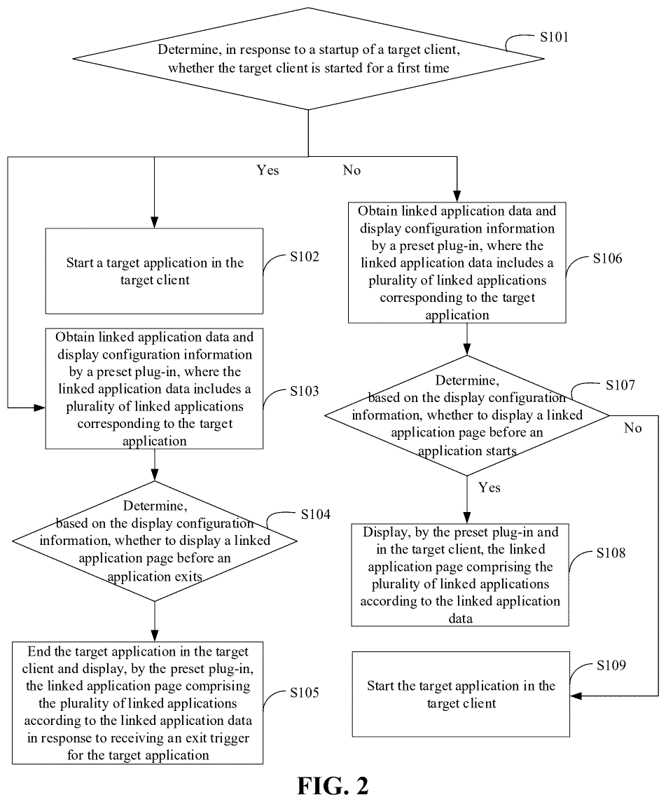

FIG. 2 further shows a flowchart of a page display method based on FIG. 1. As shown in FIG. 2, in step S101, whether the target client is started for the first time is determined. If the target client is not started for the first time, the process proceeds to step S106.

S106: linked application data and display configuration information are obtained by a preset plug-in, where the linked application data includes a plurality of linked applications corresponding to the target application.

Optionally, after the target client is not started for the first time each time, the plug-ins, the linked application data, and the display configuration information are asynchronously updated in the background.

It can be understood that considering that a version of a plug-in stored in a server may be updated at any time, after the target client is not started for the first time each time, the plug-in is requested again from the server based on the plug-in requirement information configured in the target client, to obtain the plug-ins such as the advertisement plug-in, the push plug-in, and the preset plug-in again, and reinstall a new advertisement plug-in, a new push plug-in, and a new preset plug-in, or reinstall only the updated plug-in, and do not reinstall the plug-in that is not updated.

In an exemplary embodiment, it is detected whether there is a version update of the preset plug-in. If there is a version update of the preset plug-in, the preset plug-in is updated, so that the linked application data and the display configuration information can be obtained by the updated preset plug-in.

It can be understood that considering that the linked application data corresponding to different applications stored in the server may be updated at any time, after the target client is not started for the first time each time, the linked application data is requested again from the server by the preset plug-in, to obtain the updated linked application data.

It can be understood that considering that the display configuration information corresponding to different applications stored in the server may be updated at any time, after the target client is not started for the first time each time, the display configuration information is requested again from the server by using the preset plug-in, to obtain the updated display configuration information.

S107: whether to display a linked application page before an application starts is determined based on the display configuration information. If it is determined that the linked application page is to be displayed before the application starts, the process proceeds to step S108.

The display configuration information includes a configuration of “whether to display a linked application page before an application starts”.

Optionally, if it is determined that the linked application page is not to be displayed before the application starts, the process proceeds to step S109.

S108: the linked application page including the plurality of linked applications is displayed by using the preset plug-in and in the target client according to the linked application data.

If it is determined that the linked application page is to be displayed before the application starts, the linked application page including the plurality of linked applications is displayed in the target client by using the preset plug-in according to the obtained linked application data.

S109: the target application is started in the target client.

If it is determined that the linked application page is not to be displayed before the application starts, the target application is directly started in the target client. For example, the target application is “Game A”. If it is determined that the linked application page is not to be displayed before the application starts, the “Game A” is directly started.

It can be understood that since step S106 is asynchronously performed after the target client is started, and it takes a certain amount of time to re-download and install the preset plug-in and deliver and update the linked application data and the display configuration information, the linked application data and the display configuration information in step S107 and step S108 may be linked application data and display configuration information that are asynchronously updated when the target client is last started.

Certainly, to ensure the accuracy of page display, step S107 and step S108 may be performed based on the latest linked application data and display configuration information after the latest linked application data and display configuration information are obtained, that is, after step S106.

Further, the step of obtaining the linked application data by the preset plug-in includes: requesting, by the preset plug-in, a page style and the plurality of linked applications corresponding to the target application from a server, to obtain the linked application data. Therefore, the linked application data includes the plurality of linked applications corresponding to the target application and a page style corresponding to the plurality of linked applications.

In this way, when the linked application page is displayed in the target client according to the linked application data, the plurality of linked applications in the linked application data are arranged into the linked application page according to the corresponding page style, and the linked application page is displayed in the target client by the preset plug-in.

In this embodiment, different applications may correspond to different linked applications. If the target applications corresponding to the target client are different, the corresponding plurality of linked applications are also different. For example, if the target application is a certain music game, the corresponding plurality of linked applications may be other similar music games. Alternatively, if the target application is a certain racing game, the corresponding plurality of linked applications may be other similar racing games.

In addition, different applications may further correspond to different page styles. The page style includes an arrangement layout rule of the plurality of linked applications and a respective display manner corresponding to each linked application, for example, displaying by using an icon, a video, text, or the like.

It can be understood that the linked application and the page style corresponding to each application are not fixed. That is, the linked application data corresponding to the same application may change at any time. Similarly, the display configuration information corresponding to the same application may also change as the developer changes the configuration. Therefore, the linked application data and the display configuration information need to be requested again after the target client is started each time.

It should be noted that both the target application and the linked application in the present disclosure are started in the target client through an installation-free manner such as instant launch.

In an exemplary embodiment, the target application and/or the linked application in the present disclosure may be a game application, and the plurality of linked applications are a plurality of games, and types of the plurality of games include instant-play games and/or download games.

It should be noted that an installation-free solution is used in the target client to implement installation-free startup of other applications in the target client. The installation-free solution mainly includes the following:

1. A small game (or a mini program) that can be instantly launched and runs in a host, such as an H5 small game or the like, and the target client serves as the host.

2. A cloud game. In a cloud game mode, a game is actually run on a cloud server, and the cloud server renders a game scene into a video audio stream, and transmits the video audio stream to the target client through a network.

3. A game that runs in an installation-free manner after an installation package (APK) is downloaded.

The step of starting, in response to a user selecting an application from the plurality of linked applications in the linked application page, the selected application in the target client includes: taking, in response to a user selecting a game from the plurality of games in the linked application page, the selected game as a target game, and starting, according to a type corresponding to the target game, the target game in the target client in a startup manner corresponding to the type.

In this way, the target client can start a game in different installation-free solutions according to types corresponding to different games.

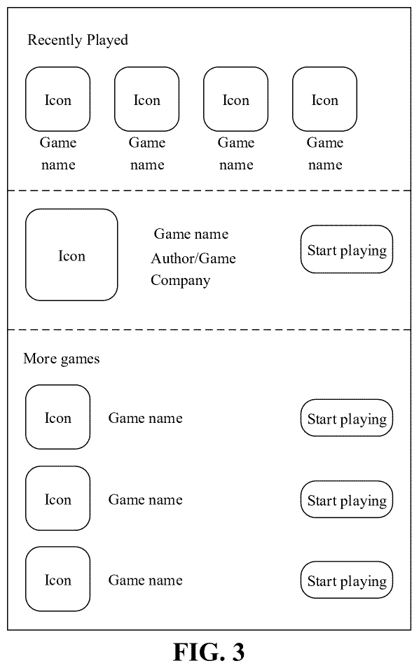

By taking the target application and the linked application as game applications as an example, FIG. 3 shows a schematic diagram of displaying a plurality of linked games according to a page style in the linked application data, that is, a schematic diagram of the linked application page, where the page style is configured as: displaying a recently played game at the top of the page, displaying a game (namely, the target application) corresponding to an icon of the target client below the recently played game, and displaying the remaining plurality of linked games below. The user clicks a “Start playing” button on the right side of a game to select the game. In response to the selection operation from the user, the game is started in the target client according to a type corresponding to the game selected by the user in a startup manner corresponding to the type.

Further, the page display method provided in the embodiments of the present disclosure further includes: if a total running duration of all applications running in the target client is less than a preset threshold within a time period corresponding to a first preset duration, replacing an icon of the target client with a preset icon; or determining an application with a longest running duration in the target client within a time period corresponding to a second preset duration, and replacing the icon of the target client with an icon corresponding to the application with the longest running duration.

In other words, the icon of the target client can be replaced. When the icon of the target client is replaced with an icon of another application, the target application corresponding to the target client changes accordingly.

For example, when it is detected that the target client has not started an application for a long time or that the running duration of the application after the application is started is short, the client icon on the desktop may be replaced with a store icon, and the name on the desktop may be changed to a store name. When it is detected that an application with a longest running duration in the target client recently is “Game B”, the client icon on the desktop may be replaced with an icon of “Game B” from the original icon of “Game A”, and the name on the desktop may be changed from “Game A” to “Game B”.

An application scenario of the page display method in this embodiment of the present disclosure may be oriented to various games that are used slightly. Such games that are used slightly have a feature that their life cycles are very short, and users will get tired of playing them soon after downloading. However, after this technical solution is used, any game client can run an application and display a linked application linked thereto in a decentralized manner, so that a linked application page, that is, a corresponding linked application, is displayed after the game exits the client and/or before the game starts in the client. Therefore, the user can select a game that the user is interested in from the page, and further start and run the game in the client. If the user is tired of the original game, when it is detected that the client runs another game for a long time, the client icon and the name on the desktop are automatically changed to an icon and a name of the game that is run for a long time, so that the client is changed to a client of the game that is run for a long time. Therefore, when the user no longer needs the game that is tired of, the user does not need to download a new game from an application store separately, and does not need to intentionally clean the client of the game that is tired of.

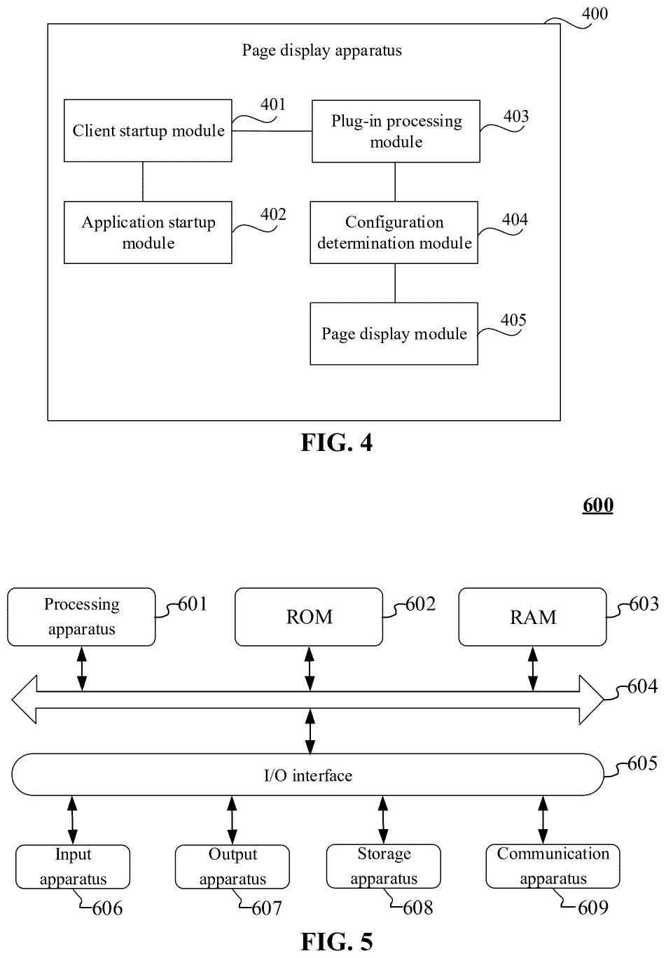

FIG. 4 is a block diagram of a page display apparatus 400 according to an exemplary embodiment. Referring to FIG. 4, the apparatus 400 includes: a client startup module 401, an application startup module 402, a plug-in processing module 403, a configuration determination module 404 and a page display module 405.

The client startup module 401 is configured to determine, in response to a startup of a target client, whether the target client is started for a first time.

The application startup module 402 is configured to, in response to determining that the target client is started for the first time, start a target application in the target client, where the target application corresponds to the target client.

The plug-in processing module 403 is configured to obtain linked application data and display configuration information by a preset plug-in, where the linked application data includes a plurality of linked applications corresponding to the target application.

The configuration determination module 404 is configured to determine, based on the display configuration information, whether to display a linked application page after an application exits.

The page display module 405 is configured to, in response to determining that the linked application page is to be displayed after the application exits, end the target application in the target client, and display, by the preset plug-in and in the target client, the linked application page including the plurality of linked applications according to the linked application data in response to receiving an exit trigger for the target application.

Optionally, the plug-in processing module 403 is further configured to, in response to determining that the target client is not started for the first time, obtain linked application data and display configuration information by a preset plug-in, where the linked application data includes a plurality of linked applications corresponding to the target application.

The configuration determination module 404 is further configured to determine, based on the display configuration information, whether to display a linked application page before an application starts.

The page display module 405 is further configured to, in response to determining that the linked application page is to be displayed before the application starts, display, by the preset plug-in and in the target client, the linked application page including the plurality of linked applications according to the linked application data.

Optionally, the application startup module 402 is further configured to start the target application in the target client in response to determining that the linked application page is not to be displayed before the application starts.

Optionally, the plug-in processing module 403 is specifically configured to, in response to determining that the target client is not started for the first time, detect whether there is a version update for the preset plug-in; and in response to determining that there is a version update for the preset plug-in, update the preset plug-in, and obtain the linked application data and the display configuration information by the updated preset plug-in.

Optionally, the plug-in processing module 403 is specifically configured to request, by the preset plug-in, a page style and the plurality of linked applications corresponding to the target application from a server, to obtain the linked application data; and the page display module 405 is specifically configured to arrange the plurality of linked applications in the linked application data into the linked application page according to the page style, and display the linked application page in the target client by the preset plug-in.

Optionally, the application startup module 402 is further configured to start, in response to a user selecting an application from the plurality of linked applications in the linked application page, the selected application in the target client.

Optionally, the plurality of linked applications are games, and types of the plurality of games include instant-play games and/or download games; and the application startup module 402 is specifically configured to take, in response to a user selecting a game from the plurality of games in the linked application page, the selected game as a target game, and start, according to a type corresponding to the target game, the target game in the target client in a startup manner corresponding to the type.

Optionally, the apparatus further includes an icon replacement module configured to, in response to determining that a total running duration of all applications running in the target client is less than a preset threshold within a time period corresponding to a first preset duration, replace an icon of the target client with a preset icon; or determine an application with a longest running duration in the target client within a time period corresponding to a second preset duration, and replace the icon of the target client with an icon corresponding to the application with the longest running duration.

The present disclosure further provides a computer-readable storage medium having a computer program stored thereon, where the program implements, when executed by a processing apparatus, the steps in the embodiments of the page display method described above.

The present disclosure further provides an electronic device, including: a storage apparatus having a computer program stored thereon; and a processing apparatus configured to execute the computer program in the storage apparatus to implement the steps in the embodiments of the page display method described above.

Reference is made to FIG. 5 below, which is a schematic diagram of a structure of an electronic device 600 suitable for implementing an embodiment of the present disclosure. The terminal device in this embodiment of the present disclosure may include, but is not limited to, mobile terminals such as a mobile phone, a notebook computer, a digital broadcast receiver, a personal digital assistant (PDA), a tablet computer (PAD), a portable multimedia player (PMP), and a vehicle-mounted terminal (such as a vehicle navigation terminal), and fixed terminals such as a digital TV and a desktop computer. The electronic device shown in FIG. 5 is merely an example, and shall not impose any limitation on the function and scope of use of the embodiments of the present disclosure.

As shown in FIG. 5, the electronic device 600 may include a processing apparatus (for example, a central processor, a graphics processor, etc.) 601 that may perform various appropriate actions and processing in accordance with a program stored in a read-only memory (ROM) 602 or a program loaded from a storage apparatus 608 into a random access memory (RAM) 603. The RAM 603 further stores various programs and data required for the operation of the electronic device 600. The processing apparatus 601, the ROM 602, and the RAM 603 are connected to each other through a bus 604. An input/output (I/O) interface 605 is also connected to the bus 604.

Generally, the following apparatuses may be connected to the I/O interface 605: an input apparatus 606 including, for example, a touchscreen, a touchpad, a keyboard, a mouse, a camera, a microphone, an accelerometer, and a gyroscope; an output apparatus 607 including, for example, a liquid crystal display (LCD), a speaker, and a vibrator; the storage apparatus 608 including, for example, a tape and a hard disk; and a communication apparatus 609. The communication apparatus 609 may allow the electronic device 600 to perform wireless or wired communication with other devices to exchange data. Although FIG. 5 shows the electronic device 600 having various apparatuses, it should be understood that it is not required to implement or have all of the shown apparatuses. It may be an alternative to implement or have more or fewer apparatuses.

In particular, according to an embodiment of the present disclosure, the process described above with reference to the flowcharts may be implemented as a computer software program. For example, this embodiment of the present disclosure includes a computer program product, which includes a computer program carried on a non-transitory computer-readable medium, where the computer program includes program code for performing the method shown in the flowchart. In such an embodiment, the computer program may be downloaded and installed from a network through the communication apparatus 609, or installed from the storage apparatus 608, or installed from the ROM 602. When the computer program is executed by the processing apparatus 601, the above-mentioned functions defined in the method of the embodiment of the present disclosure are performed.

It should be noted that the above computer-readable medium described in the present disclosure may be a computer-readable signal medium, a computer-readable storage medium, or any combination thereof. The computer-readable storage medium may be, for example but not limited to, electric, magnetic, optical, electromagnetic, infrared, or semiconductor systems, apparatuses, or devices, or any combination thereof. A more specific example of the computer-readable storage medium may include, but is not limited to: an electrical connection having one or more wires, a portable computer magnetic disk, a hard disk, a random access memory (RAM), a read-only memory (ROM), an erasable programmable read-only memory (EPROM or flash memory), an optic fiber, a portable compact disk read-only memory (CD-ROM), an optical storage device, a magnetic storage device, or any suitable combination thereof. In the present disclosure, the computer-readable storage medium may be any tangible medium containing or storing a program that may be used by or in combination with an instruction execution system, apparatus, or device. In the present disclosure, the computer-readable signal medium may include a data signal propagated in a baseband or as a part of a carrier, the data signal carrying computer-readable program code. The propagated data signal may be in various forms, including but not limited to an electromagnetic signal, an optical signal, or any suitable combination thereof. The computer-readable signal medium may also be any computer-readable medium other than the computer-readable storage medium. The computer-readable signal medium can send, propagate, or transmit a program used by or in combination with an instruction execution system, apparatus, or device. The program code contained in the computer-readable medium may be transmitted by any suitable medium, including but not limited to electric wires, optical cables, radio frequency (RF), and the like, or any suitable combination thereof.

In some implementations, the electronic device and the server may communicate by using any currently known or future-developed network protocol such as a hypertext transfer protocol (HTTP), and may be connected to digital data communication (for example, a communication network) in any form or medium, so that the electronic device can obtain various required plug-ins from the server, obtain page data of a store to be displayed, obtain display configuration information of the store, and the like. Examples of the communication network include a local area network (“LAN”), a wide area network (“WAN”), an internetwork (for example, the Internet), a peer-to-peer network (for example, an ad hoc peer-to-peer network), and any currently known or future-developed network.

The above computer-readable medium may be contained in the above electronic device. Alternatively, the computer-readable medium may exist independently, without being assembled into the electronic device.

The above computer-readable medium carries one or more programs that, when executed by the electronic device, cause the electronic device to: determine, in response to a startup of a target client, whether the target client is started for a first time; in response to determining that the target client is started for the first time, start a target application in the target client, where the target application corresponds to the target client; obtain linked application data and display configuration information by a preset plug-in, where the linked application data includes a plurality of linked applications corresponding to the target application; determine, based on the display configuration information, whether to display a linked application page after an application exits; and in response to determining that the linked application page is to be displayed after the application exits, end the target application in the target client and display, by the preset plug-in and in the target client, the linked application page including the plurality of linked applications according to the linked application data in response to receiving an exit trigger for the target application.

The computer program code for performing the operations in the present disclosure may be written in one or more programming languages or a combination thereof, where the programming languages include but are not limited to an object-oriented programming language, such as Java, Smalltalk, and C++, and further include conventional procedural programming languages, such as “C” language or similar programming languages. The program code may be completely executed on a computer of a user, partially executed on a computer of a user, executed as an independent software package, partially executed on a computer of a user and partially executed on a remote computer, or completely executed on a remote computer or server. In the circumstance involving the remote computer, the remote computer may be connected to the computer of the user over any type of network, including a local area network (LAN) or a wide area network (WAN), or may be connected to an external computer (for example, connected over the Internet using an Internet service provider).

The flowcharts and block diagrams in the accompanying drawings illustrate the possibly implemented architecture, functions, and operations of the system, method, and computer program product according to various embodiments of the present disclosure. In this regard, each block in the flowchart or block diagram may represent a module, program segment, or part of code, and the module, program segment, or part of code contains one or more executable instructions for implementing the specified logical functions. It should also be noted that, in some alternative implementations, the functions marked in the blocks may also occur in an order different from that marked in the accompanying drawings. For example, two blocks shown in succession can actually be performed substantially in parallel, or they can sometimes be performed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The modules described in the embodiments of the present disclosure may be implemented by software, or may be implemented by hardware. The name of a module does not constitute a limitation on the module in some cases. For example, an application startup module may alternatively be described as “a module for starting a target application in a target client”.

The functions described herein above may be performed at least partially by one or more hardware logic components. For example, without limitation, exemplary types of hardware logic components that may be used include: a field programmable gate array (FPGA), an application-specific integrated circuit (ASIC), an application-specific standard product (ASSP), a system on chip (SOC), a complex programmable logic device (CPLD), and the like.

In the context of the present disclosure, a machine-readable medium may be a tangible medium that may contain or store a program used by or in combination with an instruction execution system, apparatus, or device. The machine-readable medium may be a machine-readable signal medium or a machine-readable storage medium. The machine-readable medium may include, but is not limited to, electronic, magnetic, optical, electromagnetic, infrared, or semiconductor systems, apparatuses, or devices, or any suitable combination thereof. A more specific example of the machine-readable storage medium may include an electrical connection based on one or more wires, a portable computer disk, a hard disk, a random access memory (RAM), a read-only memory (ROM), an erasable programmable read-only memory (EPROM or flash memory), an optic fiber, a portable compact disk read-only memory (CD-ROM), an optical storage device, a magnetic storage device, or any suitable combination thereof.

According to one or more embodiments of the present disclosure, Example 1 provides a page display method, including:
determining, in response to a startup of a target client, whether the target client is started for a first time;
in response to determining that the target client is started for the first time, starting a target application in the target client, where the target application corresponds to the target client;
obtaining linked application data and display configuration information by a preset plug-in, where the linked application data includes a plurality of linked applications corresponding to the target application;
determining, based on the display configuration information, whether to display a linked application page after an application exits; and
in response to determining that the linked application page is to be displayed after the application exits, ending the target application in the target client and displaying, by the preset plug-in and in the target client, the linked application page including the plurality of linked applications according to the linked application data in response to receiving an exit trigger for the target application.

According to one or more embodiments of the present disclosure, Example 2 provides the method of Example 1. After determining whether the target client is started for the first time, the method further includes:
in response to determining that the target client is not started for the first time, obtaining linked application data and display configuration information by a preset plug-in, where the linked application data includes a plurality of linked applications corresponding to the target application;
determining, based on the display configuration information, whether to display a linked application page before an application starts; and
in response to determining that the linked application page is to be displayed before the application starts, displaying, by the preset plug-in and in the target client, the linked application page including the plurality of linked applications according to the linked application data.

According to one or more embodiments of the present disclosure, Example 3 provides the method of Example 2. After determining, based on the display configuration information, whether to display the linked application page before the application starts, the method further includes:
in response to determining that the linked application page is not to be displayed before the application starts, starting the target application in the target client.

According to one or more embodiments of the present disclosure, Example 4 provides the method of Example 2. In response to determining that the target client is not started for the first time, obtaining the linked application data and the display configuration information by using the preset plug-in includes:
in response to determining that the target client is not started for the first time, detecting whether there is a version update for the preset plug-in; and
in response to determining that there is a version update for the preset plug-in, updating the preset plug-in, and obtaining the linked application data and the display configuration information by the updated preset plug-in.

According to one or more embodiments of the present disclosure, Example 5 provides the method of Example 1 or Example 2. Obtaining the linked application data by the preset plug-in includes:
requesting, by the preset plug-in, a page style and the plurality of linked applications corresponding to the target application from a server, to obtain the linked application data; and
displaying, by the preset plug-in and in the target client, the linked application page including the plurality of linked applications according to the linked application data includes:
arranging the plurality of linked applications in the linked application data into the linked application page according to the page style, and displaying the linked application page in the target client by the preset plug-in.

According to one or more embodiments of the present disclosure, Example 6 provides the method of Example 1 or Example 2. After the linked application page including the plurality of linked applications is displayed in the target client by using the preset plug-in according to the linked application data, the method further includes:
starting, in response to a user selecting an application from the plurality of linked applications in the linked application page, the selected application in the target client.

According to one or more embodiments of the present disclosure, Example 7 provides the method of Example 6. The plurality of linked applications are games, and types of the plurality of games include instant-play games and/or download games. Starting, in response to a user selecting an application from the plurality of linked applications in the linked application page, the selected application in the target client includes:
taking, in response to a user selecting a game from the plurality of games in the linked application page, the selected game as a target game, and starting, according to a type corresponding to the target game, the target game in the target client in a startup manner corresponding to the type.

According to one or more embodiments of the present disclosure, Example 8 provides the method of Example 1. The method further includes:
in response to determining that a total running duration of all applications running in the target client is less than a preset threshold within a time period corresponding to a first preset duration, replacing an icon of the target client with a preset icon; or
determining an application with a longest running duration in the target client within a time period corresponding to a second preset duration, and replacing the icon of the target client with an icon corresponding to the application with the longest running duration.

According to one or more embodiments of the present disclosure, Example 9 provides a page display apparatus, including:
a client startup module configured to determine, in response to a startup of a target client, whether the target client is started for a first time;
an application startup module configured to, in response to determining that the target client is started for the first time, start a target application in the target client, where the target application corresponds to the target client;
a plug-in processing module configured to obtain linked application data and display configuration information by a preset plug-in, where the linked application data includes a plurality of linked applications corresponding to the target application;
a configuration determination module configured to determine, based on the display configuration information, whether to display a linked application page after an application exits; and
a page display module configured to, in response to determining that the linked application page is to be displayed after the application exits, end the target application in the target client and display, by the preset plug-in and in the target client, the linked application page including the plurality of linked applications according to the linked application data in response to receiving an exit trigger for the target application.

According to one or more embodiments of the present disclosure, Example 10 provides a computer-readable storage medium having a computer program stored thereon, where the program implements, when executed by a processing apparatus, the method in any of Examples 1 to 8.

According to one or more embodiments of the present disclosure, Example 11 provides an electronic device, including:
a storage apparatus having a computer program stored thereon; and
a processing apparatus configured to execute the computer program in the storage apparatus to implement the method in any of Examples 1 to 8.

The foregoing descriptions are merely preferred embodiments of the present disclosure and explanations of the applied technical principles. A person skilled in the art should understand that the scope of disclosure involved in the present disclosure is not limited to the technical solution formed by a specific combination of the foregoing technical features, and shall also cover other technical solutions formed by any combination of the foregoing technical features or equivalent features thereof without departing from the foregoing concept of disclosure. For example, a technical solution formed by replacing the foregoing features with technical features with similar functions disclosed in the present disclosure (but not limited thereto).

In addition, although the various operations are depicted in a specific order, it should be understood as requiring these operations to be performed in the specific order shown or in a sequential order. Under specific circumstances, multitasking and parallel processing may be advantageous. Similarly, although several specific implementation details are contained in the foregoing discussions, these details should not be construed as limiting the scope of the present disclosure. Some features that are described in the context of separate embodiments can also be implemented in combination in a single embodiment. In contrast, various features described in a single embodiment can also be implemented in a plurality of embodiments individually or in any suitable sub-combination.

Although the subject matter has been described in a language specific to structural features and/or logical actions of the method, it should be understood that the subject matter defined in the appended claims is not necessarily limited to the specific features or actions described above. On the contrary, the specific features and actions described above are merely exemplary forms of implementing the claims. For the apparatus in the foregoing embodiments, the specific manner in which each module performs an operation has been described in detail in the embodiments related to the method, and will not be described in detail here.

1. A page display method, comprising:
determining, in response to a startup of a target client, whether the target client is started for a first time;
in response to determining that the target client is started for the first time, starting a target application in the target client, wherein the target application corresponds to the target client;
obtaining linked application data and display configuration information by a preset plug-in, wherein the linked application data comprises a plurality of linked applications corresponding to the target application;
determining, based on the display configuration information, whether to display a linked application page after an application exits; and
in response to determining that the linked application page is to be displayed after the application exits, ending the target application in the target client and displaying, by the preset plug-in and in the target client, the linked application page comprising the plurality of linked applications according to the linked application data in response to receiving an exit trigger for the target application.

2. The method according to claim 1, wherein after determining whether the target client is started for the first time, the method further comprises:
in response to determining that the target client is not started for the first time, obtaining linked application data and display configuration information by a preset plug-in, wherein the linked application data comprises a plurality of linked applications corresponding to the target application;
determining, based on the display configuration information, whether to display a linked application page before an application starts; and
in response to determining that the linked application page is to be displayed before the application starts, displaying, by the preset plug-in and in the target client, the linked application page comprising the plurality of linked applications according to the linked application data.

3. The method according to claim 2, wherein after determining, based on the display configuration information, whether to display the linked application page before the application starts, the method further comprises:
in response to determining that the linked application page is not to be displayed before the application starts, starting the target application in the target client.

4. The method according to claim 2, wherein in response to determining that the target client is not started for the first time, obtaining the linked application data and the display configuration information by the preset plug-in comprises:
in response to determining that the target client is not started for the first time, detecting whether there is a version update for the preset plug-in; and
in response to determining that there is a version update for the preset plug-in, updating the preset plug-in, and obtaining the linked application data and the display configuration information by the updated preset plug-in.

5. The method according to claim 1, wherein obtaining the linked application data by the preset plug-in comprises:
requesting, by the preset plug-in, a page style and the plurality of linked applications corresponding to the target application from a server, to obtain the linked application data; and
wherein displaying, by the preset plug-in and in the target client, the linked application page comprising the plurality of linked applications according to the linked application data, comprises:
arranging the plurality of linked applications in the linked application data into the linked application page according to the page style, and displaying the linked application page in the target client by the preset plug-in.

6. The method according to claim 1, wherein after displaying, by the preset plug-in and in the target client, the linked application page comprising the plurality of linked applications according to the linked application data, the method further comprises:
starting, in response to a user selecting an application from the plurality of linked applications in the linked application page, the selected application in the target client.

7. The method according to claim 6, wherein the plurality of linked applications are games, and types of the plurality of games comprise instant-play games and/or download games; and starting, in response to the user selecting the application from the plurality of linked applications in the linked application page, the selected application in the target client, comprises:
taking, in response to the user selecting a game from the plurality of games in the linked application page, the selected game as a target game, and starting, according to a type corresponding to the target game, the target game in the target client in a startup manner corresponding to the type.

8. The method according to claim 1, further comprising:
in response to determining that a total running duration of all applications running in the target client is less than a preset threshold within a time period corresponding to a first preset duration, replacing an icon of the target client with a preset icon; or
determining an application with a longest running duration in the target client within a time period corresponding to a second preset duration, and replacing the icon of the target client with an icon corresponding to the application with the longest running duration.

9-10. (canceled)

11. An electronic device, comprising:
a storage apparatus having a computer program stored thereon; and
a processing apparatus configured to execute the computer program in the storage apparatus to:
determine, in response to a startup of a target client, whether the target client is started for a first time;
in response to determining that the target client is started for the first time, start a target application in the target client, wherein the target application corresponds to the target client;
obtain linked application data and display configuration information by a preset plug-in, wherein the linked application data comprises a plurality of linked applications corresponding to the target application;
determine, based on the display configuration information, whether to display a linked application page after an application exits; and
in response to determining that the linked application page is to be displayed after the application exits, end the target application in the target client and display, by the preset plug-in and in the target client, the linked application page comprising the plurality of linked applications according to the linked application data in response to receiving an exit trigger for the target application.

12. The electronic device according to claim 11, wherein after determining whether the target client is started for the first time, the processing apparatus is further configured to:
in response to determining that the target client is not started for the first time, obtain linked application data and display configuration information by a preset plug-in, wherein the linked application data comprises a plurality of linked applications corresponding to the target application;
determine, based on the display configuration information, whether to display a linked application page before an application starts; and
in response to determining that the linked application page is to be displayed before the application starts, display, by the preset plug-in and in the target client, the linked application page comprising the plurality of linked applications according to the linked application data.

13. The electronic device according to claim 12, wherein after determining, based on the display configuration information, whether to display the linked application page before the application starts, the processing apparatus is further configured to:
in response to determining that the linked application page is not to be displayed before the application starts, start the target application in the target client.

14. The electronic device according to claim 12, wherein the processing apparatus is configured to, in response to determining that the target client is not started for the first time, obtain the linked application data and the display configuration information by the preset plug-in by being configured to:
in response to determining that the target client is not started for the first time, detect whether there is a version update for the preset plug-in; and
in response to determining that there is a version update for the preset plug-in, update the preset plug-in, and obtain the linked application data and the display configuration information by the updated preset plug-in.

15. The electronic device according to claim 11, wherein the processing apparatus is configured to obtain the linked application data by the preset plug-in by being configured to:
request, by the preset plug-in, a page style and the plurality of linked applications corresponding to the target application from a server, to obtain the linked application data; and
wherein the processing apparatus is configured to display, by the preset plug-in and in the target client, the linked application page comprising the plurality of linked applications according to the linked application data by being configured to:
arrange the plurality of linked applications in the linked application data into the linked application page according to the page style, and display the linked application page in the target client by the preset plug-in.

16. The electronic device according to claim 11, wherein after displaying, by the preset plug-in and in the target client, the linked application page comprising the plurality of linked applications according to the linked application data, the processing apparatus is further configured to:
start, in response to a user selecting an application from the plurality of linked applications in the linked application page, the selected application in the target client.

17. The electronic device according to claim 16, wherein the plurality of linked applications are games, and types of the plurality of games comprise instant-play games and/or download games; and the processing apparatus is configured to start, in response to the user selecting the application from the plurality of linked applications in the linked application page, the selected application in the target client by being configured to:
take, in response to the user selecting a game from the plurality of games in the linked application page, the selected game as a target game, and start, according to a type corresponding to the target game, the target game in the target client in a startup manner corresponding to the type.

18. The electronic device according to claim 11, wherein the processing apparatus is configured to:
in response to determining that a total running duration of all applications running in the target client is less than a preset threshold within a time period corresponding to a first preset duration, replace an icon of the target client with a preset icon; or
determine an application with a longest running duration in the target client within a time period corresponding to a second preset duration, and replace the icon of the target client with an icon corresponding to the application with the longest running duration.

19. A non-transitory computer-readable storage medium having a computer program stored thereon, wherein when executed by a processing apparatus, the program implements:
determining, in response to a startup of a target client, whether the target client is started for a first time;
in response to determining that the target client is started for the first time, starting a target application in the target client, wherein the target application corresponds to the target client;
obtaining linked application data and display configuration information by a preset plug-in, wherein the linked application data comprises a plurality of linked applications corresponding to the target application;
determining, based on the display configuration information, whether to display a linked application page after an application exits; and
in response to determining that the linked application page is to be displayed after the application exits, ending the target application in the target client and displaying, by the preset plug-in and in the target client, the linked application page comprising the plurality of linked applications according to the linked application data in response to receiving an exit trigger for the target application.

20. The non-transitory computer-readable storage medium according to claim 19, wherein after determining whether the target client is started for the first time, the program further implements:
in response to determining that the target client is not started for the first time, obtaining linked application data and display configuration information by a preset plug-in, wherein the linked application data comprises a plurality of linked applications corresponding to the target application;
determining, based on the display configuration information, whether to display a linked application page before an application starts; and
in response to determining that the linked application page is to be displayed before the application starts, displaying, by the preset plug-in and in the target client, the linked application page comprising the plurality of linked applications according to the linked application data.

21. The non-transitory computer-readable storage medium according to claim 20, wherein after determining, based on the display configuration information, whether to display the linked application page before the application starts, the program further implements:
in response to determining that the linked application page is not to be displayed before the application starts, starting the target application in the target client.

22. The non-transitory computer-readable storage medium according to claim 20, wherein in response to determining that the target client is not started for the first time, obtaining the linked application data and the display configuration information by the preset plug-in comprises:
in response to determining that the target client is not started for the first time, detecting whether there is a version update for the preset plug-in; and
in response to determining that there is a version update for the preset plug-in, updating the preset plug-in, and obtaining the linked application data and the display configuration information by the updated preset plug-in.
